(19) United States
(12) Patent Application Publication
(10) Pub. No.: US 2013/0208796 A1
(43) Pub. Date: Aug. 15, 2013

(54) CACHE PREFETCH DURING A HIERARCHICAL MOTION ESTIMATION

(71) Applicants: Amichay Amitay, Hod Hasharon (IL); Alexander Rabinovitch, Kfar Yona (IL); Leonid Dubrovin, Karney Shomron (IL)

(72) Inventors: Amichay Amitay, Hod Hasharon (IL); Alexander Rabinovitch, Kfar Yona (IL); Leonid Dubrovin, Karney Shomron (IL)

(21) Appl. No.: 13/396,904

(22) Filed: Feb. 15, 2012

(51) Int. Cl. H04N 7/32; H04N 7/26

(52) U.S. Cl. 375/240.16; 375/E07.125; 375/E07.243

(57) ABSTRACT

An apparatus having a cache and a processor is disclosed. The cache may be configured to (i) buffer a first subset of a reference picture to facilitate a motion estimation of a current block at a first level of a hierarchical motion estimation and (ii) prefetch a second subset of the reference picture to the cache in response to an occurrence of a condition before the motion estimation is completed at the first level. The processor may be configured to calculate a plurality of scores by comparing the current block with the first subset of the reference picture. The second subset generally (i) resides at a second level of the hierarchical motion estimation and (ii) may be determined from the scores calculated prior to the occurrence of the condition.

### FIELD OF THE INVENTION

The present invention relates to video encoding generally and, more particularly, to a method and/or apparatus for implementing a cache prefetch during a hierarchical motion estimation.

### BACKGROUND OF THE INVENTION

Motion estimation in video compression exploits temporal redundancy within a video sequence for efficient coding. A block matching technique is widely used in the motion estimation. A purpose of the block matching technique is to find another block from a video object plane that matches a current block in a current video object plane. The matching block can be used to discover temporal redundancy in the video sequence thereby increasing the effectiveness of interframe video coding. Since a full motion estimation search for all possible hypothetical matches within a search range is intensive in terms of processing power, alternative sub-optimal techniques are commonly used. The sub-optimal techniques search a low number of hypotheses while maintaining a minimal amount of quality degradation.

An efficient motion estimation technique in terms of memory bandwidth, processing power and good visual quality is a hierarchical motion estimation. A problem in implementing the hierarchical motion estimation is the resulting non-subsequent memory accesses. A starting point of each pattern searched in a given layer of the hierarchy is determined by a best hypothesis of a previous layer of the hierarchy. Such memory accesses involve stalls (i.e., dead cycles within a core pipeline) that occur between layers. The stalls increase the number of processing cycles used in the motion estimation to perform the block matching. The stalls are conventionally avoided by reading an entire reference frame into an internal zero wait state memory. However, reading the entire reference frame is a large internal expense and uses a large die size.

It would be desirable to implement a cache prefetch during a hierarchical motion estimation.

### SUMMARY OF THE INVENTION

The present invention concerns an apparatus having a cache and a processor. The cache may be configured to (i) buffer a first subset of a reference picture to facilitate a motion estimation of a current block at a first level of a hierarchical motion estimation and (ii) prefetch a second subset of the reference picture to the cache in response to an occurrence of a condition before the motion estimation is completed at the first level. The processor may be configured to calculate a plurality of scores by comparing the current block with the first subset of the reference picture. The second subset generally (i) resides at a second level of the hierarchical motion estimation and (ii) may be determined from the scores calculated prior to the occurrence of the condition.

The objects, features and advantages of the present invention include providing a method and/or apparatus for implementing a cache prefetch during a hierarchical motion estimation that may (i) be aware of sum-of-absolute difference scores calculated during the motion estimation, (ii) determine one or more search areas in a next level to prefetch from memory, (iii) estimate potential seed locations using curve fitting parameters, (iv) calculate probabilities that the curves identify probable candidate seed locations, (v) prefetch multiple search areas to a cache based on the calculated scores at a current level and/or (vi) be implemented in a digital signal processor.

### BRIEF DESCRIPTION OF THE DRAWINGS

These and other objects, features and advantages of the present invention will be apparent from the following detailed description and the appended claims and drawings in which:

FIG. 1 is a block diagram of an example implementation of an apparatus;

FIG. 2 is a functional block diagram of a portion of an encoding operation in the apparatus;

FIG. 3 is a diagram of an example hierarchical motion estimation;

FIG. 4 is a block diagram of an example implementation of a portion of the apparatus in accordance with a preferred embodiment of the present invention;

FIG. 5 is a flow diagram of an example method for achieving the hierarchical motion estimation;

FIG. 6 is a detailed flow diagram of an example implementation of the search in the hierarchical motion estimation;

FIG. 7 is a diagram of an example search area;

FIG. 8 is a diagram of an example graph of scores along a line through the search area;

FIG. 9 is a flow diagram of an example method for handling multiple seed locations; and

FIG. 10 is a diagram of an example search area with multiple candidate scores.

### DETAILED DESCRIPTION OF THE PREFERRED EMBODIMENTS

A cache mechanism aware of a sum of absolute difference (e.g., SAD) of a previously examined hypotheses in a hierarchical motion estimation may be used to predict with certainty and/or by interpolation one or more memory accesses that may be made by the motion estimation at a next level of the hierarchy. After being predicted, the memory accesses may be prefetched to the cache in advance to avoid stalls. The prefetching generally removes the stalls caused by cache misses and thus improves the motion estimation performance by approximately 10 to 20%.

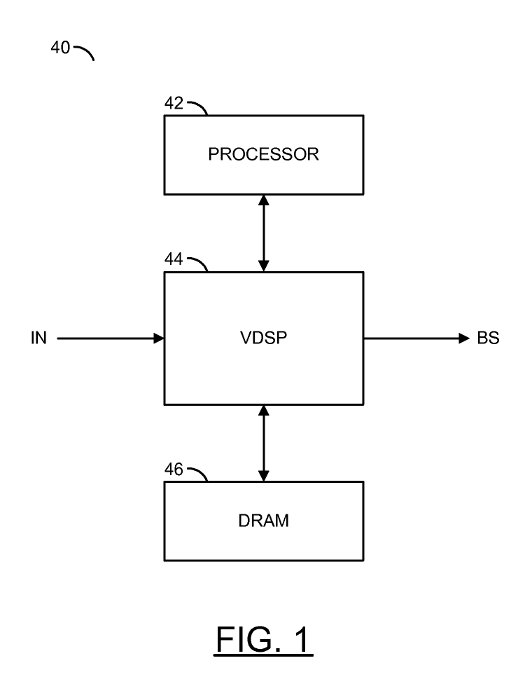

Referring to FIG. 1, a block diagram of an example implementation of an apparatus 40 is shown. The apparatus (or circuit or device or integrated circuit) 40 may implement a video encoder. The apparatus 40 generally comprises a block (or circuit) 42, a block (or circuit) 44 and a block (or circuit) 46. The circuits 42-46 may represent modules and/or blocks that may be implemented as hardware, software, a combination of hardware and software, or other implementations.

The circuit 44 may be directly coupled with the circuit 42 to exchange data and control information. The circuit 44 may be coupled with the circuit 46 to exchange data. An input signal (e.g., IN) may be received by the circuit 44. A bitstream signal (e.g., BS) may be presented by the circuit 44.

The signal IN may be one or more analog video signals and/or one or more digital video signals. The signal IN generally comprises a sequence of progressive-format frames and/or interlace-format fields. The signal IN may include synchronization signals suitable for synchronizing a display with the video information. The signal IN may be received in analog form as, but is not limited to, an RGB (Red, Green, Blue) signal, an EIA-770 (e.g., YCrCb) signal, an S-video signal and/or a Composite Video Baseband Signal (CUBS). In digital form, the signal IN may be received as, but is not limited to, a High Definition Multimedia Interface (HDMI) signal, a Digital Video Interface (DVI) signal and/or a BT.656 signal. The signal IN may be formatted as a standard definition signal or a high definition signal.

The signal BS may be a compressed video signal, generally referred to as a bitstream. The signal BS may comprise a sequence of progressive-format frames and/or interlace-format fields. The signal BS may be compliant with a VC-1, MPEG and/or H.26x standard. The MPEG/H.26x standards generally include H.261, H.264, H.263, MPEG-1, MPEG-2, MPEG-4 and H.264/AVC. The MPEG standards may be defined by the Moving Pictures Expert Group, International Organization for Standards, Geneva, Switzerland. The H.26x standards may be defined by the International Telecommunication Union-Telecommunication Standardization Sector, Geneva, Switzerland. The VC-1 standard may be defined by the document Society of Motion Picture and Television Engineer (SMPTE) 421M-2006, by the SMPTE, White Plains, N.Y.

The circuit 42 may be implemented as a processor. The circuit 42 may be operational to perform select digital video encoding operations. The encoding may be compatible with the VC-1, MPEG or H.26x standards. The circuit 42 may also be operational to control the circuit 44. In some embodiments, the circuit 42 may implement a SPARC processor. Other types of processors may be implemented to meet the criteria of a particular application. The circuit 42 may be fabricated as an integrated circuit on a single chip (or die).

The circuit 44 may be implemented as a video digital signal processor (e.g., VDSP) circuit. The circuit 44 may be operational to perform additional digital video encoding operations. The circuit 44 may be controlled by the circuit 42. The circuit 44 may be fabricated as an integrated circuit on a single chip (or die). In some embodiments, the circuits 42 and 44 may be fabricated on separate chips.

The circuit 46 may be implemented as a dynamic random access memory (e.g., DRAM). The circuit 46 may be operational to store or buffer large amounts of information consumed and generated by the encoding operations and the filtering operations of the apparatus 40. As such, the circuit 46 may be referred to as a main memory. The circuit 46 may be implemented as a double data rate (e.g., DDR) memory. Other memory technologies may be implemented to meet the criteria of a particular application. The circuit 46 may be fabricated as an integrated circuit on a single chip (or die). In some embodiments, the circuits 42, 44 and 46 may be fabricated on separate chips.

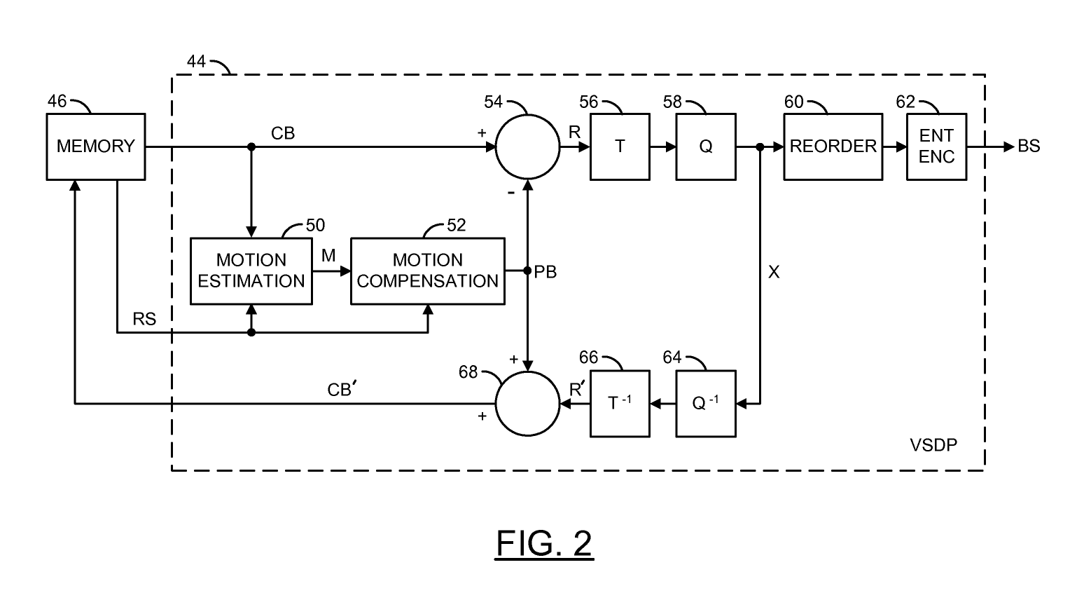

Referring to FIG. 2, a functional block diagram of a portion of an encoding operation in the circuit 40 is shown. The circuit 40 is generally operational to perform a video encoding process (or method) utilizing inter-prediction of luminance blocks of a picture. The process generally comprises a step (or state) 50, a step (or state) 52, a step (or state) 54, a step (or state) 56, a step (or state) 58, a step (or state) 60, a step (or state) 62, a step (or state) 64, a step (or state) 66 and a step (or state) 68. The steps 50-68 may represent modules and/or blocks that may be implemented as hardware, software, a combination of hardware and software or other implementations.

The steps 50 and 54 may receive a current block signal (e.g., CB) from the circuit 46. The step 50 may generate a motion vector signal (e.g., M) transferred to the step 52. A prediction block signal (e.g., PB) may be generated by the step 52 and presented to the steps 54 and 68. The step 54 may generate a residual signal (e.g., R) received by the step 56. The step 56 may present information to the step 58. A signal (e.g., X) may be generated by the step 58 and transferred to the steps 60 and 64. The step 60 may present information to the step 62. The step 62 may generate and present the signal BS. The step 64 may transfer information to the step 66. A reconstructed residual signal (e.g., R′) may be generated by the step 66 and transferred to the step 68. The step 68 may generate a reconstructed current block signal (e.g., CB') received by the circuit 46. The circuit 46 may also generate a reference sample signal (e.g., RS) presented to the steps 50 and 52.

The step 50 may implement a motion estimation step. The step 50 is generally operational to estimate a motion between a current block of a current picture (or field or frame) and a closest matching block in a reference picture (or field or frame). The estimated motion may be expressed as a motion vector that points from the current block to the closest matching reference block. The reference picture may be earlier or later in time than the current picture. The reference picture may be spaced one or more temporal inter-picture distances from the current picture. Each pixel of a picture may be considered to have a luminance (sometimes called “luma” for short) value (or sample) and two chrominance (sometimes called “chroma” for short) values (or samples). The motion estimation is generally performed using the luminance samples.

The estimation of the motion may be performed by multiple steps. The steps may include, but are not limited to, the following. A subset of a reference picture may be buffered in a cache to facilitate the motion estimation of a current block at a current level of the hierarchical motion estimation. Multiple scores may be calculated by comparing the current block with the subset of the reference picture. One or more additional subsets of the reference picture may be prefetched to the cache in response to an occurrence of a condition before the motion estimation is completed at the current level. Each additional subset generally (i) resides at a lower level of the hierarchical motion estimation below the current level and (ii) may be determined from the scores calculated prior to the occurrence of the condition. In some cases, the prefetching of additional subsets to the cache may be finished before completion of the motion estimation at the current level. The motion estimation may further include calculating interpolated reference samples at sub-pel locations between the integer pel locations. The sub-pel locations may include, but are not limited to, half-pel locations, quarter-pel locations and eighth-pel locations. The motion estimation may refine the search to the sub-pel locations.

The step 52 may implement a motion compensation step. The step 52 is generally operational to calculate a motion compensated (or predicted) block based on the reference samples received in the signal RS and a motion vector received in the signal M. Calculation of the motion compensated block generally involves grouping a block of reference samples around the motion vector where the motion vector has integer-pel (or pixel or sample) dimensions. Where the motion vector has sub-pel dimensions, the motion compensation generally involves calculating interpolated reference samples at sub-pel locations between the integer-pel locations. The sub-pel locations may include, but are not limited to, half-pel locations, quarter-pel locations and eighth-pel locations. The motion compensated block may be presented in the signal PB. The calculated (or predicted) motion compensated block may be presented to the steps 54 and 68 in the signal PB.

The step 54 may implement a subtraction step. The step 54 is generally operational to calculate residual blocks by subtracting the motion compensated blocks from the current blocks. The subtractions (or differences) may be calculated on a sample-by-sample basis where each sample in a motion compensated block is subtracted from a respective current sample in a current block to calculate a respective residual sample (or element) in a residual block. The residual blocks may be presented to the step 56 in the signal R.

The step 56 may implement a transform step. The step 56 is generally operational to transform the residual samples in the residual blocks into transform coefficients. The transform coefficients may be presented to the step 58.

The step 58 may implement a quantization step. The step 58 is generally operational to quantize the transform coefficients received from the step 56. The quantized transform coefficients may be presented in the signal X.

The step 60 may implement a reorder step. The step 60 is generally operational to rearrange the order of the quantized transform coefficients and other symbols and syntax elements for efficient encoding into a bitstream.

The step 62 may implement an entropy encoder step. The step 62 is generally operational to entropy encode the string of reordered symbols and syntax elements. The encoded information may be presented in the signal BS.

The step 64 may implement an inverse quantization step. The step 64 is generally operational to inverse quantize the transform coefficients received in the signal X to calculate reconstructed transform coefficients. The step 64 may reverse the quantization performed by the step 58. The reconstructed transform coefficients may be transferred to the step 66.

The step 66 may implement an inverse transform step. The step 66 is generally operational to inverse transform the reconstructed transform coefficients to calculate reconstructed residual samples. The step 66 may reverse the transform performed by the step 56. The reconstructed residual samples may be presented in the signal R′.

The step 68 may implement an adder step. The step 68 may be operational to add the reconstructed residual samples received via the signal R′ to the motion compensated samples received via the signal PB to generate reconstructed current samples. The reconstructed current samples may be presented in the signal CB′ to the circuit 46.

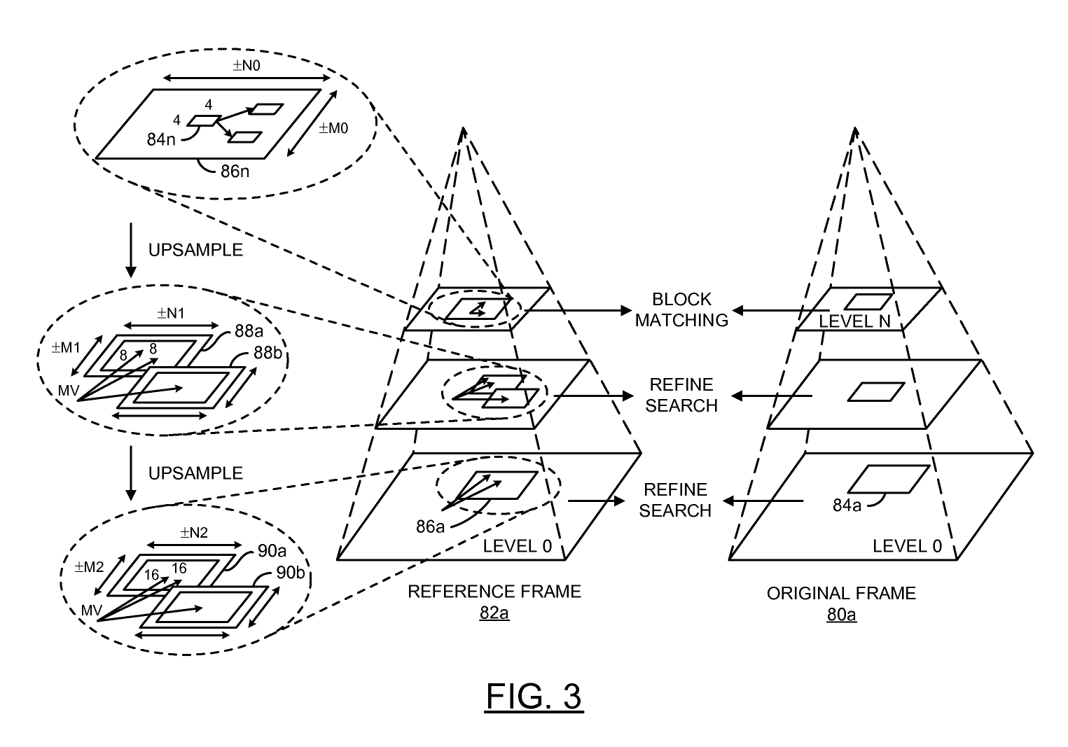

Referring to FIG. 3, a diagram of an example hierarchical motion estimation is shown. The hierarchical motion estimation may be implemented by the circuit 44 in the step 50. Blocks in a current picture 80a may be motion estimated against a reference picture 82a. In the hierarchical motion estimation, the reference picture 82a in a base level (e.g., level 0) may be decimated by a factor of two in each axis and subsequently stored in the circuit 46 as a decimated reference picture at a higher level (e.g., level 1). The process is generally repeated several times to generate decimated reference pictures at N levels respectively decimated by factors of 2, 4, 8, . . . , and 2̂N.

The current picture 80a may also be decimated repeatedly to generate decimated current pictures at the different layers. As such, a current block 84a of the current picture 80a to be motion estimated may become a decimated current block 84n at the level N.

Initial block matching may be performed at the level N over a search area 86n of the Nth decimated reference picture. Since the decimated current block 84n is small (e.g., 4×4 pixels) and so is the search area 86n (e.g., (2N0+1)×(2M0+1) pixels) due to the decimation, the block matching may be done with a relatively small amount of processing and memory bandwidth.

Once a best candidate or several best candidates are found at the level N, a level N−1 may be searched. The level N−1 is generally searched with search areas centered around the candidate seed locations (or motion vectors (e.g., MV)) found at the level N. Coordinates of the level N seed locations may be scaled (e.g., multiplied by a factor of two) to transform the locations to corresponding level N−1 seed locations. In the example illustrated, the search areas 88a and 88b in the level N−1 may be centered around the motion vectors found in the search area 86n at the level N. The decimated current block at the level N−1 generally has more detail (e.g., 8×8 pixels) than at the level N. Each search area 88a and 88b may be span fewer pixels (e.g., (2N1+1)×(2M1+1) pixels) than the search area 86n since a refined seed location is more likely to be close to the search area center.

The searching process may be repeated down to the level 0 with each successive level refining the search. For example, the search at level 1 may produce multiple motion vectors that point to the refined search areas 90a and 90b at the level 0. The current block 84a may be subsequently searched over the search areas 90a and 90b (e.g., (2N2+1)×(2M2+1) pixels) to find a best motion vector relative to the reference picture 82a. In some situations, the search may continue with portions of one or more interpolated reference pictures being searched to obtain sub-pel resolution of the final motion vector for the current block 84a. The hierarchical motion estimation is generally repeated for each current block within the current picture 80a.

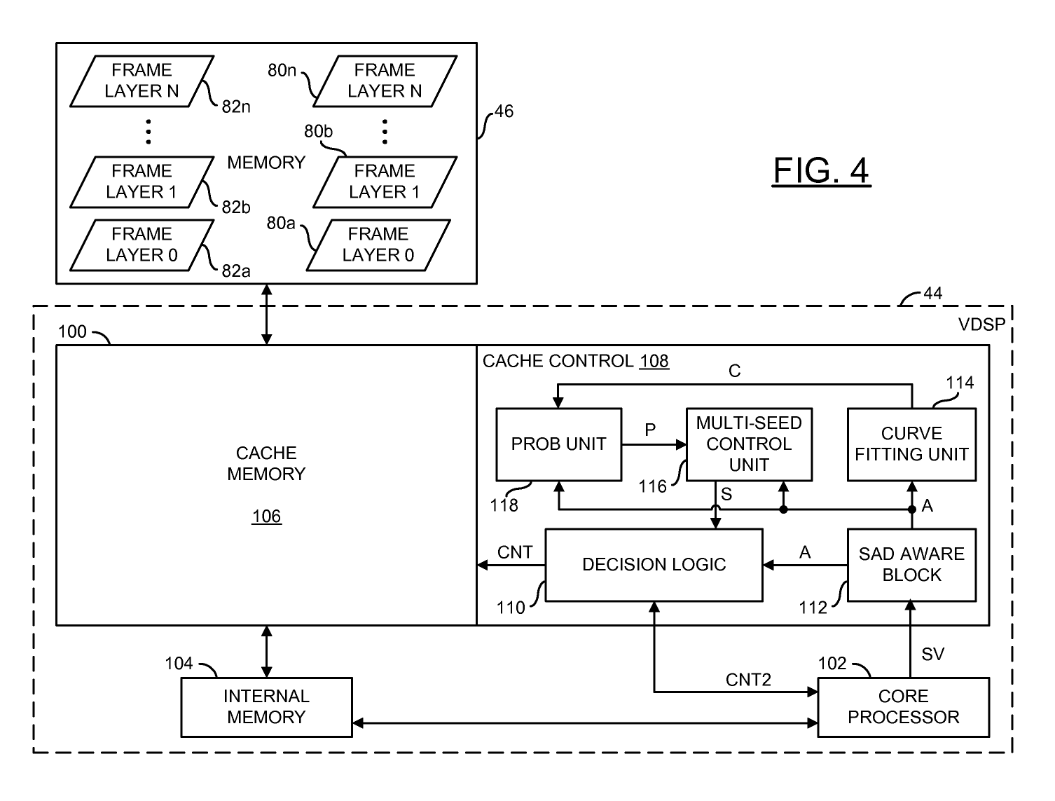

Referring to FIG. 4, a block diagram of an example implementation of a portion of the circuit 44 is shown in accordance with a preferred embodiment of the present invention. The circuit 44 generally comprises a block (or circuit) 100, a block (or circuit) 102 and a block (or circuit) 104. The circuit 100 generally comprises a block (or circuit) 106 and a block (or circuit) 108. The circuit 108 may comprise a block (or circuit) 110, a block (or circuit) 112, a block (or circuit) 114, a block (or circuit) 116 and a block (or circuit) 118. The circuits 100-118 may represent modules and/or blocks that may be implemented as hardware, software, a combination of hardware and software, or other implementations.

The circuit 106 may be bidirectionally coupled with the circuit 46 to receive the samples. A control signal (e.g., CNT) may be generated by the circuit 110 and presented to the circuit 106. The circuit 106 may be bidirectionally coupled with the circuit 104. The circuit 102 may be bidirectionally coupled with the circuit 104. A control signal (e.g., CNT2) may be exchanged between the circuits 102 and 110. The circuit 102 may generate a SAD value signal (e.g., SV) received by the circuit 112. A signal (e.g., A) may be generated by the circuit 112 and received by the circuits 110, 114, 116 and 118. The circuit 114 may generate a signal (e.g., C) that conveys curve information to the circuit 118. The circuit 118 may generate a probability signal (e.g., P) received by the circuit 116. A signal (e.g., S) carrying seed location (or motion vector) information may be generated by the circuit 116 and presented to the circuit 110.

The circuit 100 may be implemented as a cache circuit. The circuit 100 is generally operational to exchange data (e.g., samples) with the circuit 46. The circuit 100 may communicate with the circuit 102 via the signal CNT2 to decide which samples to read (e.g., fetch) from the circuit 46.

The circuit 102 may implement a core processor circuit. The circuit 102 is generally operational to execute a plurality of program instructions (e.g., software programs). The programs may include, but are not limited to, a hierarchical motion estimation process involving a block comparison process. Scores calculated by the block comparisons may be transferred in the signal SV to the circuit 112. Commands to fetch samples from the circuit 46 may be generated by the circuit 102 and presented to the circuit 110 via the signal CNT2.

The circuit 104 may implement an optional zero-wait state internal memory circuit. Where implemented, the circuit 104 may be operational to store reference samples and the current block samples used in the block comparisons. The circuit 104 may be utilized by the circuit 102 as a search memory. Where the circuit 104 is not implemented, the circuit 102 may receive the reference samples and the current block samples used in the block comparisons directly from the circuit 106.

The circuit 106 may implement a cache memory. The circuit 106 may be operational to buffer one or more subsets of the reference samples of the reference pictures and the current samples of the current block to facilitate the motion estimation of the current block. The reference samples and current samples read from the circuit 46 may be copied to the circuit 104. The samples fetched and/or prefetched from the circuit 46 may be (i) buffered in the circuit 106 until requested by the circuit 102 and/or (ii) copied into the circuit 104. In some embodiments, the circuit 106 may be utilized by the circuit 102 as the search memory.

The circuit 108 may implement a cache control circuit. The circuit 108 is generally operational to control all operations of the circuit 106 in response to commands receive from the circuit 102 and the SAD values.

The circuit 110 may implement a decision logic circuit. The circuit 110 is generally operational to fetch reference pixels in search areas and current pixels of the current block from the circuit 46 to the circuit 106 in response to commands received from the circuit 102 via the signal CNT2. The circuit 110 may also be operational to prefetch one or more additional subsets of the reference pictures from the circuit 46 to the circuit 106 in response to an occurrence of a condition before the motion estimation is completed at the current level.

The circuit 112 may implement an SAD aware block. The circuit 112 is generally operational to buffer the SAD values (scores) of the locations (seeds or motion vectors) already tested by the circuit 102 in the current iteration. The scores may be presented to the circuits 110, 114, 116 and 118 via the signal A. The scores may be used by the circuit 110 to help determine which locations have already been tested and which locations remain to be tested.

The relationship between the searched locations and the unsearched locations may be used to trigger prefetching of reference samples at the next lower level of the hierarchy from the circuit 46 to the circuit 106. By way of example, consider a case where prefetching search area of the next hierarchy generally takes a small fraction (e.g., ⅛th) of the cycles used for the complete search at the current hierarchy level. A condition generally occurs where a large fraction (e.g., ⅞ths) of the current level has been searched. When the condition occurs, the best one or more candidate locations (seeds or motion vectors) up to that occurrence may be treated as the best motion predictors of the entire level search. Therefore, prefetching may begin to read the corresponding search areas for the next layer. In most cases, the best candidates when the condition happens may be global candidates for two reasons. First, most of the search was already considered. If the probability distribution of the best seed location is evenly spread in the search area, an 87.5% chance exists that the best candidate has already been found. Secondly, in many cases the probability distribution of the best seed location may be spread unevenly in the search area. However, due to the correlation of the motion in several consecutive macroblocks, a best motion vector of the current macroblock is commonly in a small area around the middle of the search area (or range). Therefore, a high probability generally exists that the globally best motion vector may be in the initial ⅞ths of the search area.

The circuit 114 may implement a curve fitting unit. The circuit 114 is generally operational to correlate one or more curves to an array of the scores. The circuit 114 generally tries to fit some curve (e.g., a two dimensional second-order polynomial curve) to the score array. A reasonably fitting curve may be used to estimate a minimum point of the curve function by using the polynomial parameters. If the minimum point is located inside the searched area, a score of a true minimum point may be calculated by the circuit 102. On the other hand, if the minimum point appears to be outside the already searched area and into a point that was still not searched (e.g., in the last ⅛ of the search area or even outside the search area) the circuit 110 may prefetch the estimated minimum point from the next layer using the estimation. The search area around the estimated minimum point might be fetched instead of or in parallel to the best searched locations. The curves may be presented by the circuit 114 to the circuit 118 in the signal C.

The circuit 118 may implement a probability calculation unit. The circuit 118 is generally operational to calculate how well the curves fit the scores (e.g., the SAD data received in the signal A) by calculating correlation values of the curves relative to the actual scores. If a correlation value exceeds a threshold, the curve may be a reliable estimation of the predicted minimum point. If the correlation value does not exceed the threshold, the predicted minimum point may be discarded. The reliable predicted minimum points may be transferred to the circuit 116 via the signal P.

The circuit 116 may implement a multi-seed control unit. The circuit 116 may be operational to identify and buffer one or more best seed locations for refining the search at the next lower level of the hierarchy. In many cases, the hierarchical search generates more than a single seed for the next layer. As such, several regions each of a given size around a “best” prediction point of the current level may be searched on the next lower level. In some cases, some minimal spatial distance between the seed locations may be enforced. The minimal spatial distance criteria generally avoids local minimum points since a point that fits slightly better in a decimated frame might fit slightly worse in the next level down. Using the several seeds plus minimum distance (to avoid several representatives of the same local minimal point) usually assures that the best global candidates may be selected.

The circuit 116, in combination with the circuits 110, 112, 114 and 118, generally assists to identify which candidate seed locations should be kept and which should be ignored. Since N seeds may be searched at the next lower level, some of the seed locations (e.g., M seeds, where M<N) that were examined up to the point where the condition occurred may be made with certainty (or some probability) as part of the N final seeds. Once the N final seed locations have been identified, the circuit 110 may prefetch the corresponding search areas from the next level.

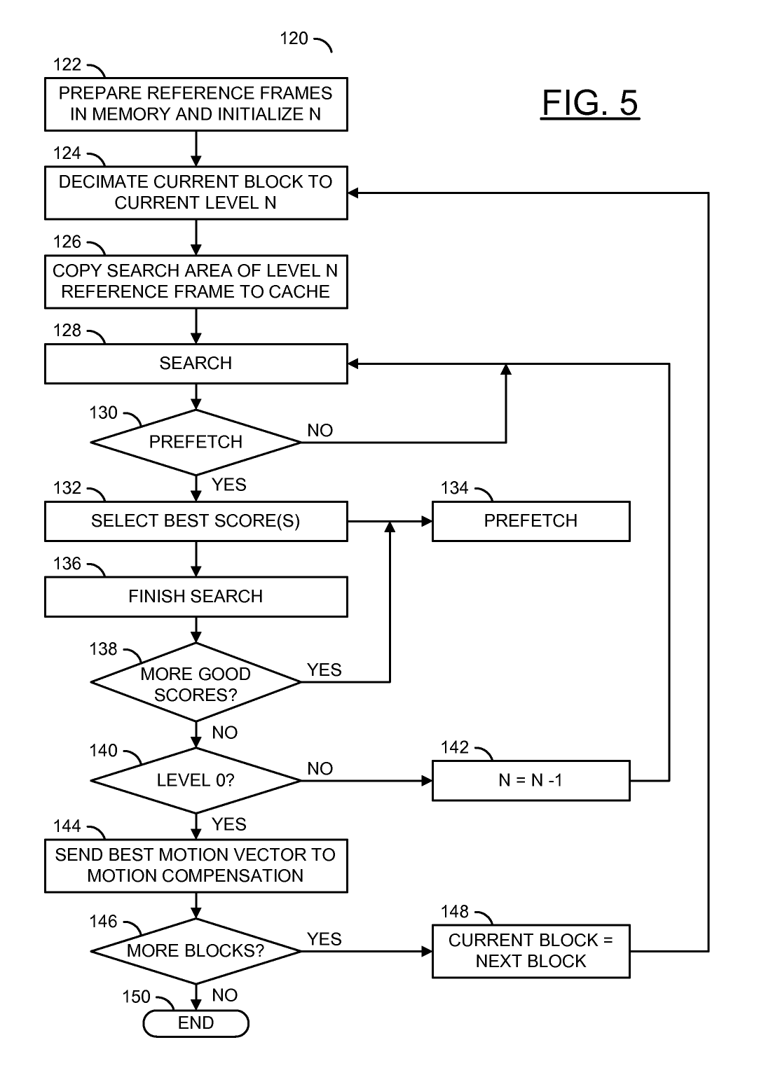

Referring to FIG. 5, a flow diagram of an example method 120 for a hierarchical motion estimation is shown. The method (or process) 120 may be implemented by the circuits 44 and 46. The method 120 generally comprises a step (or state) 122, a step (or state) 124, a step (or state) 126, a step (or state) 128, a step (or state) 130, a step (or state) 132, a step (or state) 134, a step (or state) 136, a step (or state) 138, a step (or state) 140, a step (or state) 142, a step (or state) 144, a step (or state) 146, a step (or state) 148 and a step (or state) 150. The steps 122-150 may represent modules and/or blocks that may be implemented as hardware, software, a combination of hardware and software, or other implementations.

In the step 122, the circuit 44 may prepare one or more reference pictures for the hierarchical motion estimation by decimating the reference pictures to each level of the hierarchy and storing the decimated reference pictures in the circuit 46. A counter N may also be initialized to the top level in the step 122. The circuit 44 may also decimate a current block being motion estimated to the various levels of the hierarchy and store the decimated current block in the circuit 46 in the step 124. A copy of the search area of the decimated reference frame at the current level N and the decimated current block at the current level N may be copied (fetched) in the step 126 from the circuit 46 to the circuit 106. In the step 128, a motion estimation search for the decimated current block in the level N search area may be performed by the circuit 102. The motion estimation search generally involves calculating a score (e.g., SAD value) for each block match of the current block at each location of the search area.

In the step 130, the circuit 108 (e.g., 110) may determine if the condition has occurred. If not, the method 120 may continue to search in the step 128. When the condition occurs, the circuit 108 (e.g., 116) may select the best one or more scores in the step 132. The best scores may be presented in the signal S to the circuit 110 which begins to prefetch the corresponding search areas at the level N−1 in the step 134. While the prefetch is in progress, the circuit 102 may continue and ultimately finish the search at the level N in the step 136.

Once the search at the level N has finished, the circuit 108 may consider in the step 138 other scores calculated after the prefetching was started in the step 134. if one or more good seed locations were discovered, the circuit 110 may add the newly discovered good seed locations to the prefetch task of the step 134. if no more good seed locations were encountered, the method 120 may continue with the step 140.

In the step 140, the circuit 108 may check to see if the level just searched was the last level (e.g., level 0). If not, the counter N may be decremented in the step 142. The method 120 may return to the step 128 to refine the motion estimations at the next level. The loop around the steps 128-142 may continue until all of the levels have been considered.

After all of the levels have been considered, the motion estimation 50 may transfer the best motion vector of the current block to the motion compensation 52 in the step 144. A check may be performed in the step 146 to determine if any more blocks in the current frame remain to the motion estimated. If more blocks remain, the next block to be considered may be identified as a new current block and the method 120 resumes with the step 124. When all of the blocks in the current frame have been motion estimated, the method 120 may end in the step 150.

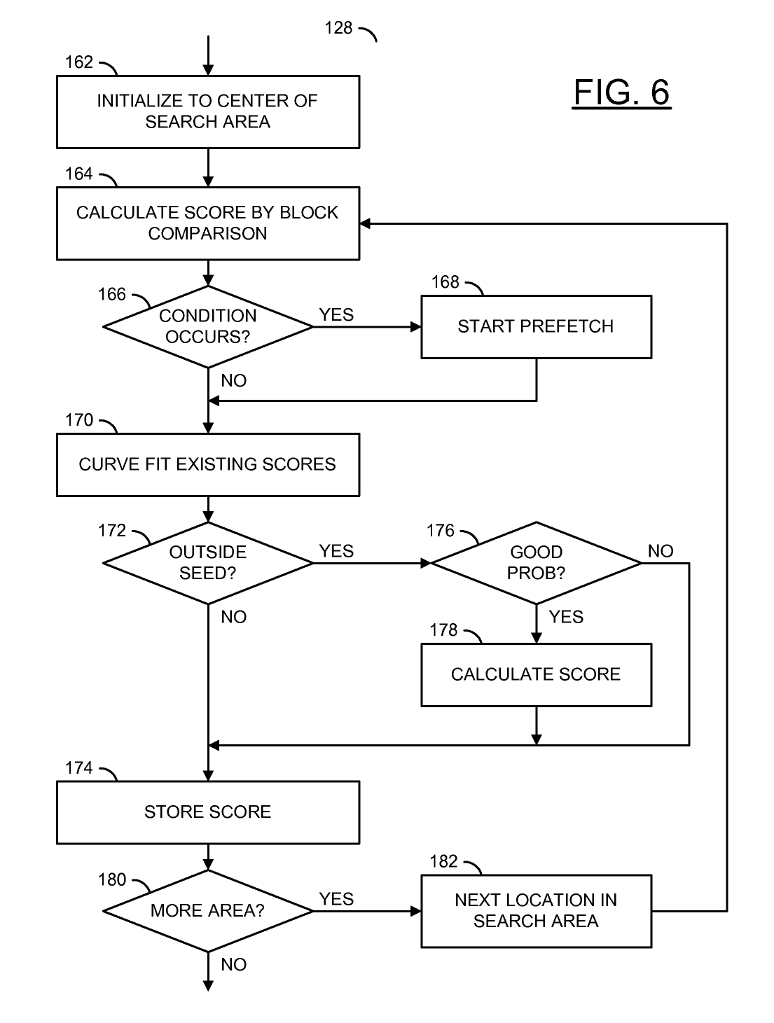

Referring to FIG. 6, a detailed flow diagram of an example implementation of the search step 128 is shown. The step 126 generally comprises a step (or state) 162, a step (or state) 164, a step (or state) 166, a step (or state) 168, a step (or state) 170, a step (or state) 172, a step (or state) 174, a step (or state) 176, a step (or state) 178, a step (or state) 180 and a step (or state) 182. The steps 162-182 may represent modules and/or blocks that may be implemented as hardware, software, a combination of hardware and software, or other implementations.

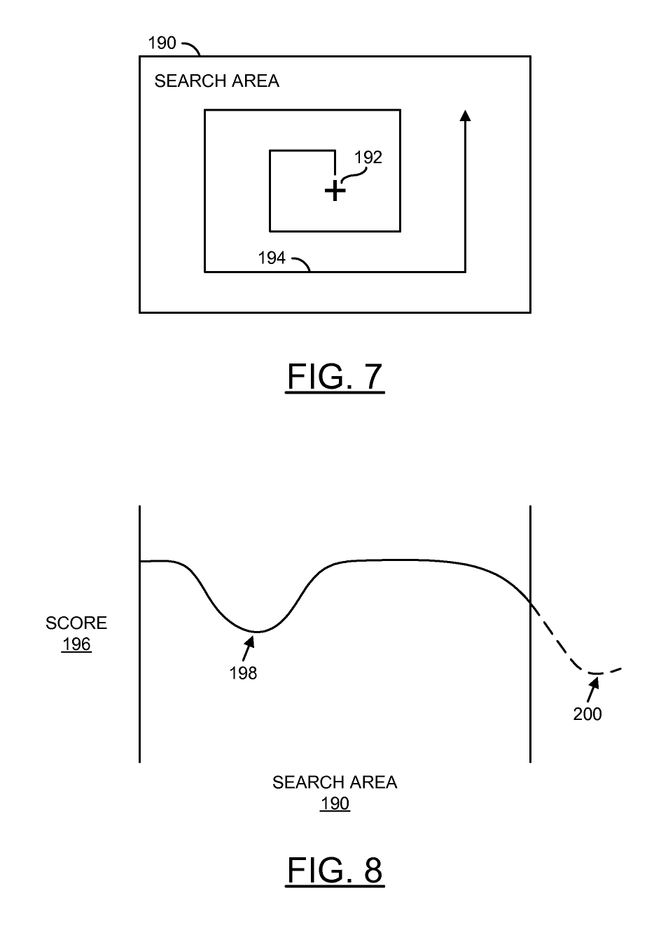

Referring to FIG. 7, a diagram of an example search area 190 is shown. Returning to FIG. 6, in the step 162 the circuit 102 may initialize the motion estimation search to a center 192 of the search area 190. A score for the center location 192 may be calculated in the step 164 by the circuit 102. The score may be transferred to the circuit 112 via the signal SV. A check may be performed by the circuit 112 in the step 166 to determine if the prefetch condition has occurred. If the condition occurs (e.g., ⅞ths of the search area has been considered), the circuit 112 may signal the circuit 110 to begin the prefetch of the next search areas at the next lower level. The circuit 110 may perform the prefetch in the step 134 (FIG. 5).

Referring to FIG. 8, a diagram of an example graph of the score 196 along a line through the search area 190 is shown. Returning to FIG. 6, if the condition has not yet occurred, the circuit 114 may fit one or more curves to the already-calculated scores in the step 170. The block matching used in the motion estimation generally identifies good (e.g., low-valued) scores at one or more locations, for example, location 198. However, the block matching generally does not consider points outside the search area and/or points not yet compared, for example, the location 200. The curve fitting performed by the circuit 114 may estimate the minimal locations, such as the location 200, as candidate seed locations. If the estimated locations fall within the search area 190, the step 128 may continue with the step 174. If the estimated locations fall outside the search area 190, the circuit 118 may calculate the probability that the estimation is good or poor in the step 176. If the probability is good (e.g., above the correlation threshold), a score value of the estimated minimal location 200 may be calculated in the step 178. The process may continue with the step 174.

In the step 174, the scores may be stored while the motion estimation continues. A check may be made by the circuit 112 in the step 180 to determine if more of the search area has yet to be considered. If locations within the search area remain to be tested, the circuit 100 (e.g., 102) may move the block matching to the next location in the step 182. The search may continue with the step 164 to calculate a score for the next location. The loop around the steps 164-182 may continue until all of the locations of the search area have been scored.

The odds of finding the best seed locations before the condition is triggered may be increased further if a search pattern of the entire search area 190 is not a raster scan pattern. Instead, a search pattern 194 may be implemented that moves from the center 192 outwards. If a better predictor is identified after the condition has occurred and the prefetching has begun, the circuit 108 may either (i) terminate the current prefetch and start prefetching the better seed location for the next level or (ii) continue with the ongoing prefetch and add the better seed location into the prefetch task. In a worst case, identifying the best seed location after the prefetch has started may lead to a stall until the corresponding search area is available in the circuit 106. However, in most cases, a reduced number of stalls or no stalls may be experienced as the prefetching allows the motion estimation at the next level to begin immediately after finishing at the current level.

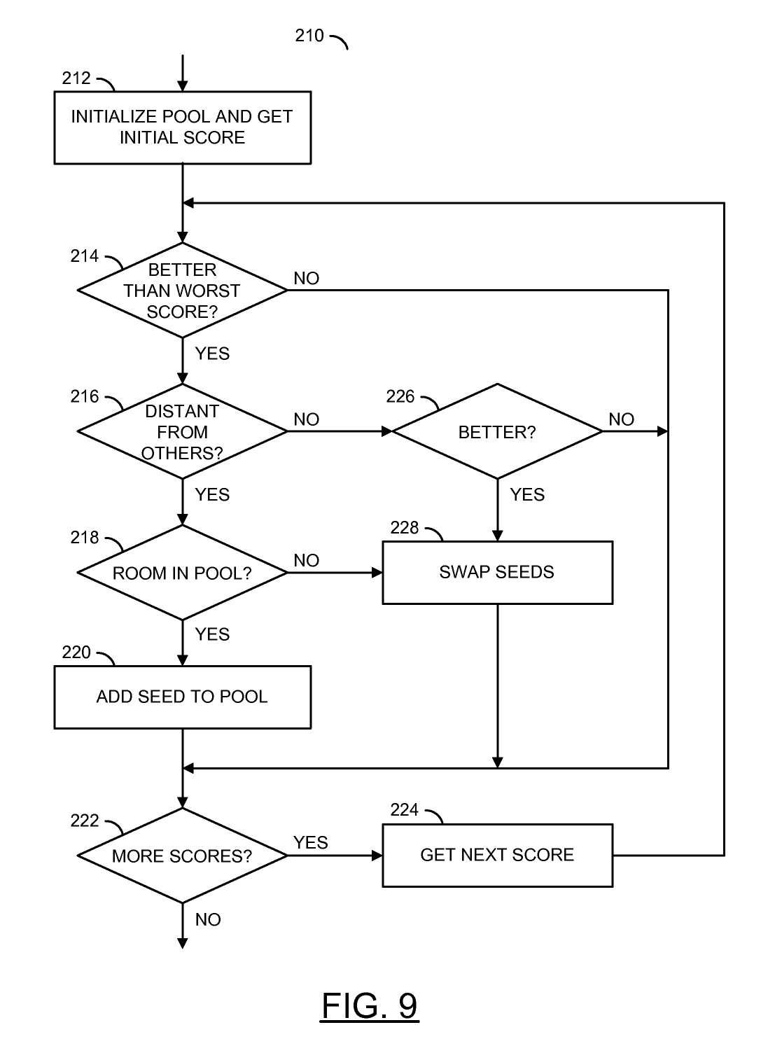

Referring to FIG. 9, a flow diagram of an example method 210 for handling multiple seed locations is shown. The method (or process) 210 may be implemented by the circuit 116. The method 210 generally comprises a step (or state) 212, a step (or state) 214, a step (or state) 216, a step (or state) 218, a step (or state) 220, a step (or state) 222, a step (or state) 224, a step (or state) 226 and a step (or state) 228. The steps 212-228 may represent modules and/or blocks that may be implemented as hardware, software, a combination of hardware and software or other implementations.

In the step 212, the circuit 116 may initialize a pool of potential seed locations to a null set, initialize a best score in the pool to a worst score value and get an initial calculated score from the circuit 112. A check may be performed in the step 214 to determine if the initial calculated score is better than the worst score in the pool. If not, the method 210 may continue with another score in the step 222. If the current calculated score is better than the worst score currently in the pool, the circuit 116 may check for a spatial distance from the current score to other scores in the pool in the step 216. The distance check may be used to avoid adjacent and/or adjoining seed locations from being over represented in the pool.

If the separation distance exceeds a threshold distance, the circuit 116 may determine if room exists in the pool for an additional seed location in the step 218. If room exists, the current score may be added to the pool as a new candidate seed location in the step 220. In the step 222 a check may be made to see if any additional scores are available to consider. If one or more additional scores are available, the circuit 116 may get the next score and return to the step 214. Once all of the scores have been considered, the method 210 may end.

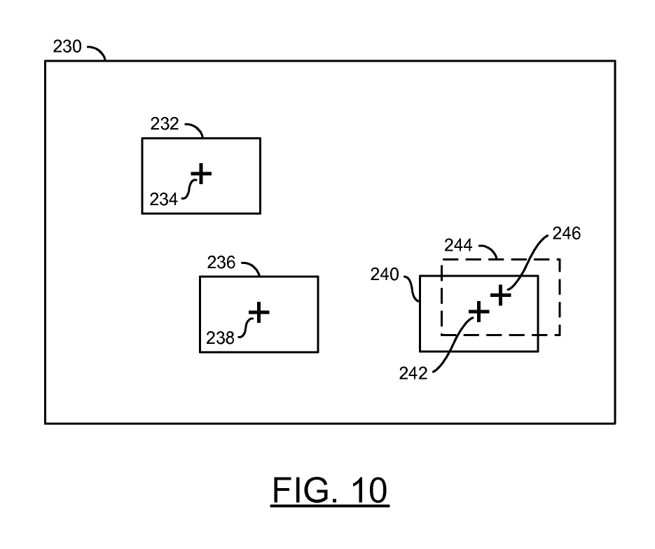

Referring to FIG. 10, a diagram of an example search area 230 with multiple candidate scores is shown. In some situations, a current score may be better than one or more scores currently in the pool, but the corresponding location 246 is less than the threshold distance from an existing location (e.g., location 242) in the pool. Returning to FIG. 9, if the current score (e.g., at location 246) is better than the nearby score (e.g., at the location 242) per the step 226, the circuit 116 may swap the better current score for the poorer nearby score in the step 228. As such, the search area 244 around the location 246 may be prefetched instead of the search area 240 around the location 242. If the nearby score (e.g., at location 242) is better than the current score (e.g., at the location 246), the method 210 may continue with the step 222 and check for more scores. As such, the search area 240 around the location 242 may be prefetched instead of the search area 244 around the location 246.

In some situations, (i) a current score (e.g., at location 234) may be better than one or more scores (e.g., at location 238) currently in the pool and (ii) the corresponding location 234 is greater than the threshold distance from all other locations (e.g., locations 238 and 242) in the pool. In such situations, the circuit 116 may swap the better current score for the worst existing score (e.g., at the location 238) in the pool at the step 228. As such, the search area 232 around the location 234 may be prefetched instead of the search area 236 around the location 238.

The functions performed by the diagrams of FIGS. 1-10 may be implemented using one or more of a conventional general purpose processor, digital computer, microprocessor, microcontroller, RISC (reduced instruction set computer) processor, CISC (complex instruction set computer) processor, SIND (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. An apparatus comprising:
a cache configured to (i) buffer a first subset of a reference picture to facilitate a motion estimation of a current block at a first level of a hierarchical motion estimation and (ii) prefetch a second subset of said reference picture to said cache in response to an occurrence of a condition before said motion estimation is completed at said first level; and
a processor configured to calculate a plurality of scores by comparing said current block with said first subset of said reference picture, wherein said second subset (i) resides at a second level of said hierarchical motion estimation and (ii) is determined from said scores calculated prior to said occurrence of said condition.

2. The apparatus according to claim 1, wherein said cache is further configured to finish said prefetching of said second subset before completion of said motion estimation at said first level.

3. The apparatus according to claim 1, wherein said cache is further configured to prefetch a third subset of said reference picture in response to an additional score calculated after said occurrence of said condition.

4. The apparatus according to claim 1, wherein (i) said cache is further configured to prefetch one or more third subsets of said reference picture to said cache in response to said occurrence of said condition and (ii) each of said third subsets (a) comprises a corresponding part of said reference picture at said second level and (b) is determined from said scores calculated prior to said occurrence of said condition.

5. The apparatus according to claim 1, wherein (i) said cache is further configured to (a) fit a curve to said scores and (b) prefetch a third subset of said reference picture in response to said curve indicating that a match to said current block exists outside of said first subset and (ii) said third subset resides at said second level.

6. The apparatus according to claim 5, wherein said cache is further configured to calculate a probability that said curve corresponds to an additional score suitable to refine at said second level.

7. The apparatus according to claim 1, wherein said cache is further configured to (i) calculate a spatial distance between at least two locations of said scores suitable to refine at said second level and (ii) drop at least one of said scores from said refinement in response to said spatial distance being less than a threshold distance.

8. The apparatus according to claim 1, wherein said condition occurs when a given amount of said first subset has been searched.

9. The apparatus according to claim 1, wherein said apparatus is implemented in a video encoder.

10. The apparatus according to claim 1, wherein said apparatus is implemented as one or more integrated circuits.

11. A method for cache prefetch during a hierarchical motion estimation, comprising the steps of:
(A) buffering in a cache a first subset of a reference picture to facilitate a motion estimation of a current block at a first level of said hierarchical motion estimation;
(B) calculating a plurality of scores by comparing said current block with said first subset of said reference picture; and
(C) prefetching a second subset of said reference picture to said cache in response to an occurrence of a condition before said motion estimation is completed at said first level, wherein said second subset (i) resides at a second level of said hierarchical motion estimation and (ii) is determined from said scores calculated prior to said occurrence of said condition.

12. The method according to claim 11, further comprising the step of:
finishing said prefetching of said second subset to said cache before completion of said motion estimation at said first level.

13. The method according to claim 11, further comprising the step of:
prefetching a third subset of said reference picture to said cache in response to an additional score calculated after said occurrence of said condition.

14. The method according to claim 11, further comprising the step of:
prefetching one or more third subsets of said reference picture to said cache in response to said occurrence of said condition, wherein each of said third subsets (i) comprises a corresponding part of said reference picture at said second level and (ii) is determined from said scores calculated prior to said occurrence of said condition.

15. The method according to claim 11, further comprising the steps of:
fitting a curve to said scores; and
prefetching a third subset of said reference picture to said cache in response to said curve indicating that a match to said current block exists outside of said first subset, wherein said third subset resides at said second level.

16. The method according to claim 15, further comprising the step of:
calculating a probability that said curve corresponds to an additional score suitable to refine at said second level.

17. The method according to claim 11, further comprising the steps of:
calculating a spatial distance between at least two locations of said scores suitable to refine at said second level; and
dropping at least one of said scores from said refinement in response to said spatial distance being less than a threshold distance.

18. The method according to claim 11, wherein said condition occurs when a given amount of said first subset has been searched.

19. The method according to claim 11, wherein said method is implemented in a video encoder.

20. An apparatus comprising:
means for buffering a first subset of a reference picture to facilitate a motion estimation of a current block at a first level of a hierarchical motion estimation;
means for calculating a plurality of scores by comparing said current block with said first subset of said reference picture; and
means for prefetching a second subset of said reference picture to said means for buffering in response to an occurrence of a condition before said motion estimation is completed at said first level, wherein said second subset (i) resides at a second level of said hierarchical motion estimation and (ii) is determined from said scores calculated prior to said occurrence of said condition.
